(19) United States
(12) Patent Application Publication
(10) Pub. No.: US 2017/0338076 A1
(43) Pub. Date: Nov. 23, 2017

(54) X-RAY RADIATION GENERATOR

(71) Applicant: Smiths Heimann GmbH, Wiesbaden (DE)

(72) Inventors: Gregor Hess, Wiesbaden (DE); Kai Lenz, Wiesbaden (DE); Michael Hirt, Frankfurt (DE); Alexander Adam, Mainz (DE); Andreas Streyl, Seibersbach (DE)

(21) Appl. No.: 15/522,909

(22) PCT Filed: Oct. 30, 2015
(86) PCT No.: PCT/EP2015/075271

§ 371 Date: Apr. 28, 2017

(30) Foreign Application Priority Data
Oct. 30, 2014 (DE) 10 2014 222 164.1

(51) Int. Cl. H01J 35/12

(52) U.S. Cl. CPC H01J 35/12; H01J 2235/1295

(57) ABSTRACT

The present invention relates to an X-ray tube (30) with an anode (36) that conducts a high voltage, preferably greater than 120 kV, particularly preferably greater than 300 kV, and heats up during operation, wherein the anode is connected in a thermally conductive way to a heat sink (4), which has a base body (10.4) composed of a metal with a heat absorbing surface (12.4) for coupling to the anode (36) as a heat source (36) and a heat dissipating surface (14.4) that is enlarged by means of heat dissipating elements (16.4) that are connected to the base body (10.4), wherein the heat dissipating elements (16.4) are composed of an electrically insulating material having a thermal conductivity on the same order of magnitude as that of the metal of the base body (10.4), and wherein the heat dissipating elements (16.4) have a height (H) starting from the base body (10.4) of the heat sink (4) so that taking into account the high voltage and an insulating medium surrounding the heat dissipating elements (16.4), there is a sufficient insulation breakdown resistance relative to the surroundings of the X-ray tube (30).

In general, the present invention relates to an X-ray tube with an anode that conducts a high voltage, preferably greater than 120 kV, particularly preferably greater than 300 kV, and heats up during operation. In particular, the invention relates to an X-ray tube with a heat sink, which is suitable for cooling the high voltage-conducting anode in cases where space is limited.

### BACKGROUND OF THE INVENTION

X-ray tubes are known as an example of an X-ray radiation generator. To avoid voltage flashovers, it is necessary to insulate high voltage-conducting parts such as anodes from other parts in the vicinity by providing sufficient insulation.

For example, in order to increase insulation breakdown resistance, DD 139 327 A proposes that a housing of an X-ray tube additionally have a sleeve built into it, which is composed of a dielectric material such as epoxy resin with quartz flour, ceramic, or PTFE, which essentially contains a bulb of the X-ray tube inserted therein and covers the X-ray tube radially relative to the housing. The additional dielectric material provides better electrical shielding or insulation of the anode of the tube from the surroundings. DE 10 2008 006 620 A1 discloses an X-ray tube in which the tubular housing of the tube is composed of a ceramic. The subassemblies for generating the X-ray radiation are contained in the housing. The anode of an X-ray tube heats up during operation; to avoid damage due to overheating, the heat is usually dissipated from the anode by means of a heat sink.

Passive heat sinks increase the heat-dissipating surface area of a heat-generating component and are essentially known, for example from DE 20 2007 007 568 U1.

Known heat sinks are usually composed of a metal with high thermal conductivity such as aluminum or copper. In a heat sink composed of metal, in the part of the anode lying outside the housing of the X-ray tube, a minimum distance must be maintained between the heat sink and other components or housing parts connected to a reference potential (e.g. ground, GND, etc.) in order to prevent voltage flashovers. If the X-ray tube is to be operated with higher voltages, then this safety distance must be correspondingly increased. This can make it necessary to enlarge the outer housing of a system in which the X-ray tube is contained.

An insulation sleeve of the kind in DD 139 327 A would impair the heat dissipation. Alternatively, it is possible to use a heat sink composed of a ceramic with good thermal conduction properties such as aluminum oxide or aluminum nitride. A heat sink composed of ceramic, however, is expensive to produce since special molds must be used. In addition, the metal of the anode—usually copper—has a higher thermal expansion coefficient than the externally mounted ceramic heat sink. This makes the heat transmission between the anode and the heat sink problematic: on the one hand, the heat sink should have the best possible heat conduction contact with the anode in order to achieve the highest possible heat transfer coefficient. On the other hand, the heat sink must be prevented from being damaged or even exploding due to the mechanical stress generated by the expansion of the anode when heated.

The design requirement “as compact as possible” is fundamental to many devices. The size of an X-ray radiation generator is limited at the lower end by the fact that certain components must be integrated into it and by the fact that the distances between the components that are contacted by a different electrical potential must be selected so that the breakdown resistance of the insulating mediums is not exceeded at any point.

### DISCLOSURE OF THE INVENTION

The object of the invention is to propose an X-ray tube, in particular a vacuum X-ray tube, with an anode that conducts a high voltage, preferably greater than 120 kV, particularly preferably greater than 300 kV, and heats up during operation, in which the insulation breakdown resistance of the anode, which is operated with higher voltages, relative to the surroundings is improved.

The object is attained with the features of the independent claim 1. Exemplary embodiments and advantageous modifications are defined in the subsequent dependent claims.

A central concept of the invention lies in the fact that a base body of a heat sink, as an interface with the preferably metal anode that is to be cooled, is embodied of a metal that has a high thermal conductivity such as aluminum (Al) or copper (Cu) and in order to increase the surface area for heat transmission to the surroundings, the base body heat is provided with dissipating elements such as cooling pins and/or cooling fins made of a ceramic that has a good thermal conductivity, but is electrically insulating, for example aluminum nitride (AlN) or silicon carbide (SiC). By means of this special embodiment of the heat sink, it is advantageously possible to satisfy three requirements: (i) the component to which the heat sink is attached can be cooled by means of thermal radiation and primarily convection; (ii) the insulation distance relative to adjacent components that contact a different electrical potential is increased, e.g. in comparison to a conventional all-metal- or full-metal heat sink; and (iii) voltage problems that can be produced due to differing thermal expansion coefficients between the ceramic and the component to be cooled can be compensated for by means of the base body as a transition piece. Finally, the combination of inexpensive components and the additional function of electrical insulation make the heat sink according to the invention superior to known heat sinks composed of aluminum or ceramic.

A first aspect of the invention thus relates to an X-ray tube with a heat sink for the anode, which heat sink has a base body made of metal. The surface of the base body has a heat absorbing surface for coupling to the anode as a heat source and a heat dissipating surface for dissipating heat, particularly through thermal radiation and convection. In order to enlarge the heat dissipating surface, heat dissipating elements are connected to the base body and/or are inserted into the base body. The heat dissipating elements are composed of an electrically insulating material whose thermal conductivity coefficient is on the same order of magnitude as that of the metal of the base body.

The base body can be composed of a metal with good thermal conductivity properties. Preferably, the base body is composed of a metal or a metal alloy that has a thermal conductivity coefficient of at least 100 W/(m K), preferably greater than 200 W/(m K). For example, suitable candidates for this metal are aluminum (Al), copper (Cu), silver (Ag), or an alloy of these metals.

The material of the electrically insulating heat dissipating elements preferably has a thermal conductivity coefficient of greater than 100 W/(m K). In this context, “electrically insulating” means that the material has a specific resistance of at least 10¹² Ω*m/mm² and more. The heat dissipating elements are preferably composed of a ceramic. For example, silicon carbide (SiC) or aluminum nitride (AlN) is suitable candidates for the ceramic.

Suitable combinations with regard to the material selection for the base body and the heat dissipating elements include, for example, copper/silicon carbide or aluminum/aluminum nitride.

The heat dissipating elements can, for example, be plate-shaped and/or pin-shaped and/or tubular. In other words, the heat dissipating elements have at least one of the following forms: plates, pins, or tubes. Basically, other shapes can also be used, which are suitable for enlarging the heat dissipating surface area on the one hand and for fastening to the base body by means of a measure explained further below.

The base body preferably has a corresponding socket or recess for each heat dissipating element. Each socket or recess is dimensioned in accordance with the shape of a connecting section of a heat dissipating element to be inserted.

The heat dissipating elements, i.e. the connecting sections, can be connected to the base body by means of nonpositive, frictional engagement. For example, each connecting section can be fastened in the associated socket by means of a press fit or clamping. In order to be able to insert the ceramic heat dissipating element, which is produced so that it is oversized relative to the socket, into the socket in the metallic base body, it is possible to heat the base body. When the base body cools, a press-fit, so to speak, is then produced by the shrinking of the base body onto the connecting section of the heat dissipating element. Since ceramic is very good at absorbing compressive forces, this connection fits in well with the strength properties of the ceramic. By means of the press fit, compression forces are induced on the connecting section, which is situated inside the base body, so that the metal/ceramic connection can easily absorb the stresses produced by the pressing. In addition, the press fit achieves a particularly good heat transfer from the base body to the heat dissipating elements.

If the heat dissipating elements are pin-shaped or tubular at least in the region of the connecting section, then a first thread can be molded or machined into the connecting section. Correspondingly, the sockets in the base body are embodied in the form of holes with a second thread that corresponds to the first thread. The heat dissipating elements can then be connected to the base body by screwing each of the connecting sections into the respective socket. The thread also advantageously increases the contact area and thus the thermal transmission area between the base body and the individual heat dissipating elements.

The heat dissipating elements can also be connected to the base body by being cast into it. In this case, the connecting sections and the sockets are dimensioned so that an interstice exists or is produced between the respective connecting section and the associated socket. This interstice becomes or is filled or cast with a casting compound in order to fasten the heat dissipating element in the socket. In this case, it is not absolutely necessary for the sockets in the base body and the connecting sections of the heat dissipating elements to have a cross-section that is matched to each other. It is only necessary for each respective socket to be dimensioned so that the associated connecting section can be inserted into it. The casting compound does not have to absorb powerful forces and only serves to durably position the respective heat dissipating element in the metallic base body.

The heat dissipating elements can also be integrally bonded to the base body, for example by being glued in place with an organic or inorganic adhesive.

For example, organic casting compounds or epoxy resin-based adhesives are suitable for filling in gaps between the ceramic/metal parts or for gluing ceramic/metal parts. For higher application temperatures, it is suitable to use inorganic-based casting compounds or adhesives that contain mineral fillers such as aluminum oxide (Al2O3), zirconium oxide (ZrO2), and/or magnesium oxide (MgO) and a binder phase composed of water glass, water-soluble aluminosilicates, and/or phosphates. Examples for thermally conductive adhesives that should be cited here include Soltabond SB2001, SB5102-4, or SB5314 made by the company Soltabond GmbH.

The heat dissipating elements can also be integrally joined to the base body by means of soldering. In this case, preferably, at least the connecting section of the heat dissipating element is metallized in order to enable a wetting of the material with the solder. Copper and aluminum oxide ceramic and a titanium-copper-silver-based solder should be cited here as an example of a metal-ceramic combination and a suitable solder.

Basically, the base body of the heat sink can be a CNC-produced metal part.

The base body of the heat sink for the anode can be tubular, in particular cylindrical. If the base body is essentially a cylinder, then it can be produced as a turned element. The heat absorbing surface is then comprised of an inner surface of a recess extending axially in the base body. The shape of the recess is adapted to the coupling with the anode as a heat source. The remaining surface of the base body is once again part of the heat dissipating surface in which the sockets for the heat dissipating elements are embodied. Preferably, a heat dissipating element is inserted into each of these sockets and is fastened in a way that conducts heat well.

In a special embodiment of the heat sink, the recesses are provided in the form of slots or grooves extending axially in the outer surface of the base body. Heat dissipating elements in the form of plate-shaped ceramic elements are inserted into these recesses with form-fitting engagement, with nonpositive, frictional engagement, or in an integrally joined way.

A heat sink according to the invention is particularly suitable for use in an electrical device having a component that conducts a high voltage and heats up during operation; the heat sink is connected to this component in a thermally conductive way.

The X-ray tube has the anode as a component that conducts a high voltage and heats up during operation. A heat sink is connected to the anode in a thermally conductive way. Preferably, the heat dissipating elements have a height that starts from the base body of the heat sink. Particularly preferably, the height is dimensioned so that when the high voltage and possibly an insulating medium surrounding the heat dissipating elements are taken into account, a predetermined sufficient insulation breakdown resistance vis-à-vis the surroundings is achieved and/or ensured.

In practice, the size of the X-ray tube is limited at the lower end by the fact that certain components must be integrated into it and by the fact that the distances between the components that are contacted by different electrical potential must be selected so that the breakdown resistance of the insulating medium provided between them is not exceeded. In this case, the component to be cooled is essentially the anode of the X-ray tube. In a particularly advantageous way, the base body of the heat sink in this case serves as a transition piece between the anode that heats up during operation (as a heat-generating component) and the ceramic heat dissipating elements, which function as cooling fins.

Since the anode is usually rotationally symmetrical in the connecting region, the base body of the heat sink can be produced in a particularly simple way as a turned element.

In order to join the insulating elements to the base body, slots or grooves can be provided in the base body by means of a CNC machine. The slots or grooves are matched to the dimensions of the connecting sections of the heat dissipating elements in accordance with the selected joining technique. Ceramic plates are particularly well-suited for use as heat dissipating elements since they are available in the form of inexpensive, mass-production articles.

### PREFERRED EXEMPLARY EMBODIMENTS

Other advantages, features, and details of the invention ensue from the following description, in which exemplary embodiments of the invention are described in detail with reference to the drawings. The features mentioned in the claims and in the description can each be essential to the invention by themselves or in any combination with one another. Likewise, the features mentioned above and explained in greater detail below can be used by themselves or in any combination with one another. Parts or components that are functionally similar or identical are sometimes provided with the same reference numerals. The terms “left,” “right,” “above,” and “below” used in the description of the exemplary embodiments refer to the drawings in a direction with normally legible figure number and normally legible reference numerals. The embodiments depicted and described are not to be taken as comprehensive and instead, have an exemplary character intended for explanation of the invention. The detailed description is provided in order to inform the person skilled in the art; for this reason, known circuits, structures, and methods are not depicted or explained in detail in the description in order not to hamper comprehension of the present description.

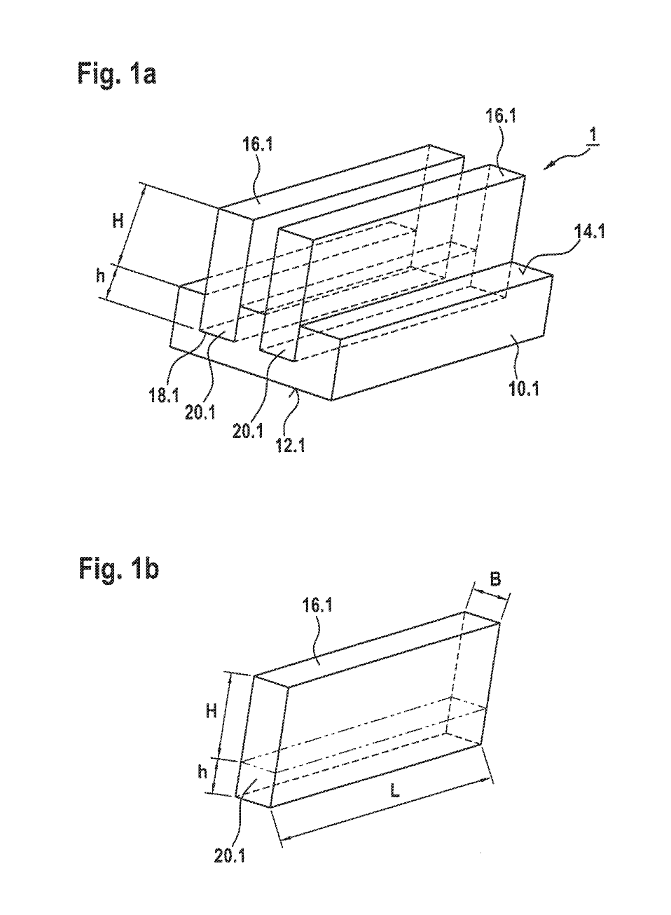

FIGS. 1a and 1 b show a first exemplary embodiment of a heat sink.

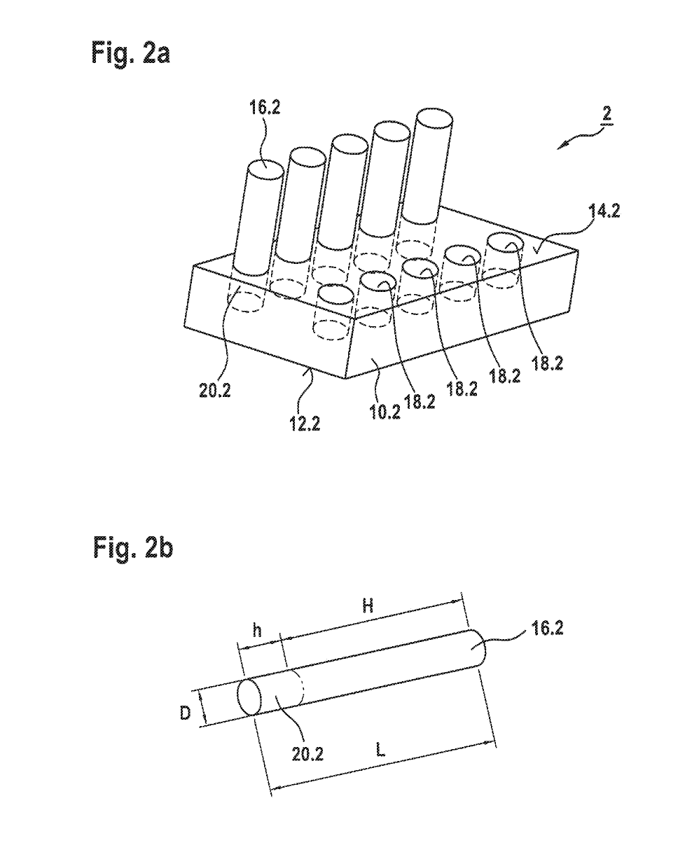

FIGS. 2a and 2b show a second exemplary embodiment of a heat sink.

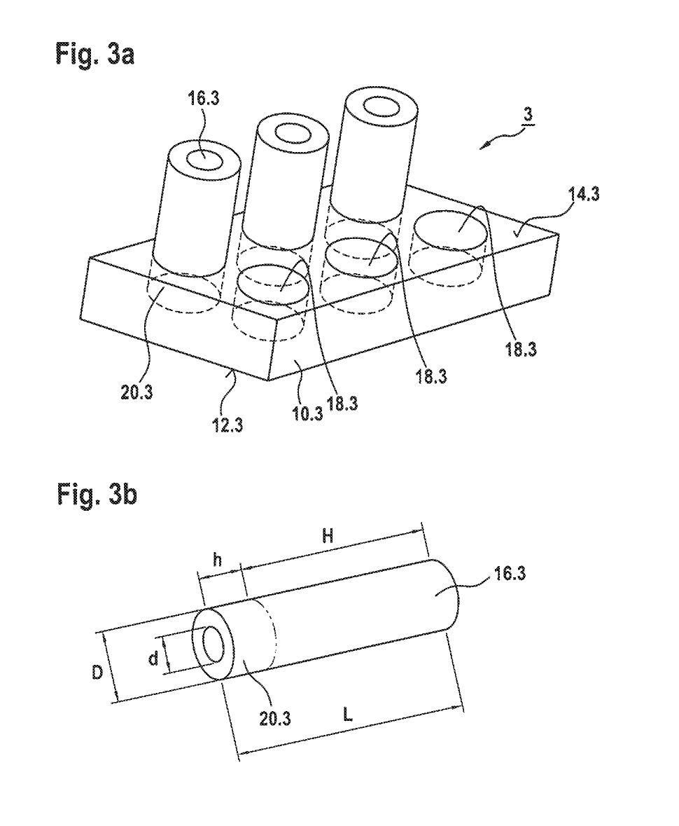

FIGS. 3a and 3b show a third exemplary embodiment of a heat sink.

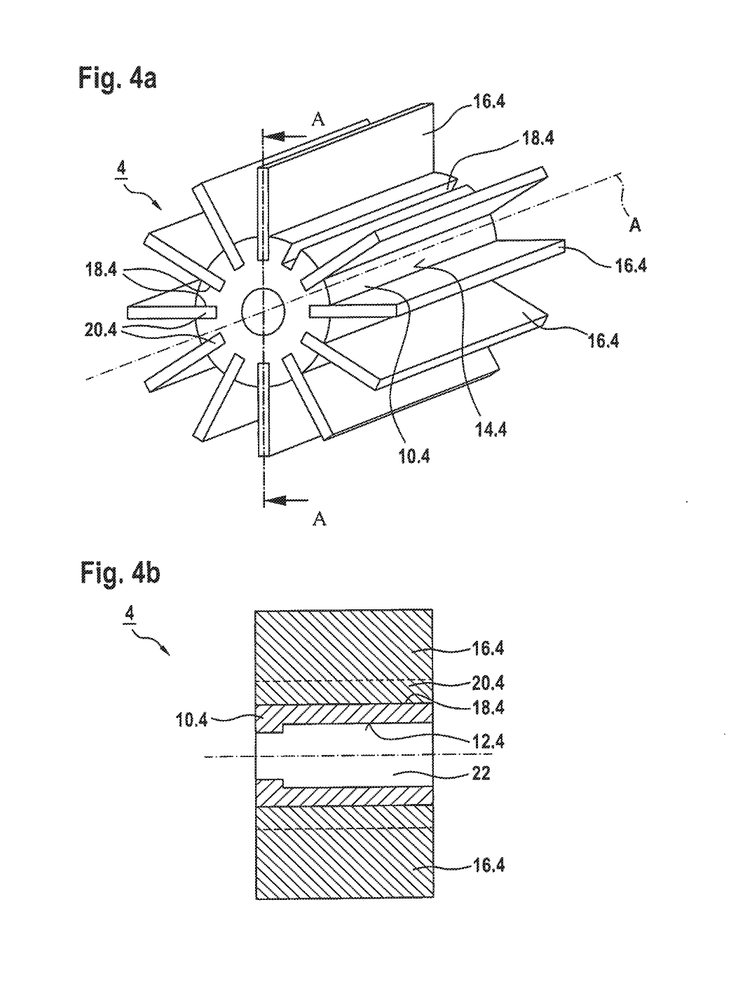

FIG. 4a shows a fourth exemplary embodiment of a heat sink with a cylindrical base body made of metal and cooling fins made of ceramic.

FIG. 4b shows the cross-section AA of FIG. 4a.

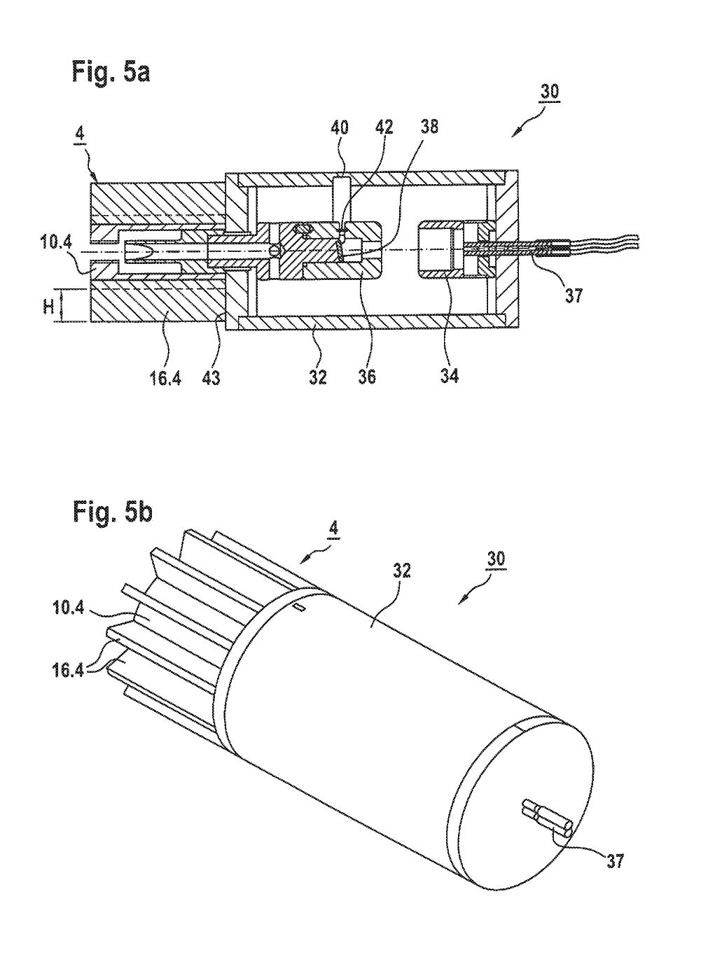

FIG. 5a shows a cross-section of an X-ray tube with the heat sink from FIGS. 4a and 4b functioning as an anode heat sink.

FIG. 5b is a perspective view of the X-ray tube of FIG. 5a.

The FIGS. 1a to 3b show three exemplary embodiments for heat sinks 1, 2, and 3, each having a base body 10.1, 10.2, 10.3 made of metal.

The base body has a respective heat absorbing surface 12.1, 12.2, 12.3 for coupling to a heat source. The heat source can be a component, which heats up or is heated during operation. During operation, heat is conveyed into the base body of the heat sink in a known way by means of thermal conduction. In other words, the heat absorbing surface essentially corresponds to the contact area with the heat source.

By means of thermal conduction, thermal radiation, and convection via its outer surfaces that are not in contact with the heat source, the base body 10.1, 10.2, 10.3 can, as a heat dissipating surface, dissipate the heat to an insulating medium (usually a fluid such as the ambient air in the simplest case) surrounding the heat dissipating surfaces. Essentially, the part of the outer surface of the base body 10.1, 10.2, 10.3, which is situated opposite from the heat absorbing surface 12.1, 12.2, 12.3, constitutes the heat dissipating surface 14.1, 14.2, 14.3 of the base body 10.1, 10.2, 10.3.

To enlarge the effective heat dissipating surface, with heat dissipating elements 16.1, 16.2, 16.3, which are connected to the base body 10.1, 10.2, 10.3 in a thermally conductive way, are situated on the base body 10.1, 10.2, 10.3 in the region of the heat dissipating surface 14.1, 14.2, 14.3. The heat dissipating surface area 14.1, 14.2, 14.3 of the base body 10.1, 10.2, 10.3 is thus increased by the surface areas of the heat dissipating elements 16.1, 16.2, 16.3. The heat dissipating elements 16.1, 16.2, 16.3 are made of an electrically insulating material, which preferably has a thermal conductivity on the same order of magnitude as that of the metal of the base body 10.1, 10.2, 10.3. The respective connecting sections 20.1, 20.2, 20.3 of the heat dissipating elements 16.1, 16.2, 16.3 are inserted into correspondingly shaped sockets 18.1, 18.2, 18.3, which are molded into the base body 10.1, 10.2, 10.3 in a way that conducts heat into the base body 10.1, 10.2, 10.3.

FIG. 1a shows the first exemplary embodiment of the heat sink 1 with plate-shaped heat dissipating elements 16.1. FIG. 1b shows one of the heat dissipating elements 16.1 from FIG. 1a by itself. The heat dissipating element 16.1 is embodied in the shape of a plate, i.e. it is plate-shaped.

The expression “plate-shaped” essentially means that the heat dissipating element 16.1 has significantly greater dimensions in length and height than it does in comparison to the width.

The plate-shaped heat dissipating element 16.1 has a width B and a height, which is composed of a height h of the connecting section 20.1 and the remaining length H with which the latter protrudes from the base body 10.1 after being inserted into it. The longitudinal span of the heat dissipating element 16.1 is labeled L. Since B<<L and B<<(h+H), the heat dissipating element is plate-shaped.

With the connecting section 20.1, the heat dissipating element 16.1 is inserted into the recesses 18.1 provided or embodied in the base body 10.1 and is then fastened in it in a thermally conductive way by means of one of the measures discussed below.

FIG. 2a shows the second exemplary embodiment of the heat sink 2. In this case, the heat dissipating elements 16.2 are pins or rods, which are composed of an electrically insulating material and once again have a thermal conductivity on the same order of magnitude as that of the metal of the base body 10.2. Similar to what is shown in FIG. 1a, the pin-shaped or rod-shaped heat dissipating elements 16.2 are inserted with a respective connecting section 20.2 into recesses 18.2 correspondingly machined or molded into the base body 10.2 and are fastened therein with high thermal conductivity.

One of the pin-shaped heat dissipating elements 16.2 is shown by itself in FIG. 2b. The heat dissipating element 16.2 is essentially cylindrical and has a length L and a diameter D. The length L is of the connecting section 20.2, which similar to the one in FIGS. 1a and 1b, has the length h that corresponds to the depth of one of the respective sockets 18.2 in the base body 10. The remaining part of the pin-shaped heat dissipating element 16.2 has the length H that protrudes from the base body 10.2 when the heat dissipating element 16.2 has been inserted into the base body 10.2; in other words, L equals (h+H) in this case.

FIG. 3a shows the third exemplary embodiment of the heat sink 3. In this case (as in the first and second exemplary embodiment), the heat dissipating surface 14.3 of the base body 10.3 has sockets 18.3 formed in it, into which the tubular heat dissipating elements 16.3 are inserted and fastened. The tubular heat dissipating elements 16.3 are once again composed of an electrically insulating material having a thermal conductivity on the same order of magnitude as that of the metal of the base body 10.3. The tubular heat dissipating elements 16.3 in the exemplary embodiment are in the form of a hollow cylinder with an outer diameter D, an inner diameter d, and a length L. The length of the heat dissipating element 16.3 is divided into the connecting section 20.3 with a length h, which sections are inserted to a depth h into the correspondingly formed sockets 18.3 of the base body 10.3. The remaining section of the heat dissipating element 16.3 that protrudes from the base body 10.3 when the heat dissipating element 16.3 has been inserted into the base body 10.3, has the length H; in other words, here—as in FIGS. 2a and 2b—L equals (h+H).

As mentioned above, in the heat sinks 1, 2, and 3 described in conjunction with FIGS. 1a to 3b, the base body 10.1, 10.2, 10.3 is made out of a metal with a high thermal conductivity, preferably with a thermal conductivity coefficient of 100 W/(m K) or more. For the exemplary embodiments, aluminum with a thermal conductivity coefficient of approx. 240 W/(m K) or copper with a thermal conductivity coefficient of approx. 400 W/(m K) is used. Naturally, the base body 10.1, 10.2, 10.3 can also be composed of another metal or metal alloy.

The heat dissipating elements 16.1, 16.2, and 16.3 are composed of a ceramic that has a thermal conductivity coefficient on the same order of magnitude as that of the metal of the base body 10.1, 10.2, 10.3. Preferably, the ceramic thus likewise has a thermal conductivity coefficient of greater than 100 W/(m K). For the exemplary embodiments, aluminum nitride with a thermal conductivity coefficient of approx. 180 to 220 W/(m K) or silicon carbide with a thermal conductivity coefficient of approx. 350 W/(m K) was used.

As is clear from FIGS. 1a, 2a, and 3a, the heat dissipating elements 16.1, 16.2, and 16.3 are each inserted into corresponding sockets 18.1, 18.2, and 18.3 that have been produced in the base body 10.1, 10.2, 10.3. Various joining techniques can be used to ensure a sufficient fastening of the heat dissipating elements 16.1, 16.2, and 16.3 that has a particularly good thermal conductivity.

For example, in the exemplary embodiments shown in FIGS. 1a and 2a, the respective heat dissipating element 16.1 or 16.2 can be joined to the base body 10.1, 10.2 with form-fitting engagement and/or with frictional, nonpositive engagement in that the respective use section 20.1, 20.2 is fastened in the associated socket 18.1, 18.2 by means of a press fit or by means of clamping. In order to insert the heat dissipating elements into the corresponding sockets in the base body 10.1, 10.2, it is possible, for example, to correspondingly heat the base body 10.1, 10.2 so that the base body 10.1, 10.2 expands. In this state, the ceramic heat dissipating elements 16.1, 16.2 can be inserted into the respective sockets 18.1, 18.2. Once the base body 10.1, 10.2 has cooled again, the heat dissipating elements 16.1, 16.2 are firmly attached to the base body 10.1, 10.2. In this case, it is only necessary to make sure that the dimensions of the recesses 18.1, 18.2 are sized so that the heat dissipating elements 16.1, 16.2 cannot come loose due to the expansion of the metal of the base body 10.1, 10.2 at the temperatures that are achieved during proper operation.

An alternative fastening variant is possible in the exemplary embodiments of FIGS. 2a and 3a. To this end, a first thread can be machined or molded into the heat dissipating elements 16.2, 16.3, at least in the region of the respective connecting section 20.2, 20.3 (not shown). Then corresponding second threads can be machined into the corresponding sockets 18.2, 18.3 in the base body 10.2, 10.3, which in this case are then embodied in the form of holes. Correspondingly, the heat dissipating elements 16.2, 16.3 can be connected to the base body 10.2, 10.3 in that the connecting sections 20.2, 20.3 are each fastened in the respective socket 18.2, 18.3 by means of being screwed into it. If the base body 10.2, 10.3 heats up and thus expands during operation of the heat sink, the ceramic heat dissipating elements 16.2, 16.3 are only subjected to compressive strain, which additionally reduces the heat transfer resistance between the base body and the heat dissipating elements.

Alternatively, the heat dissipating elements 16.1, 16.2, or 16.3 of the exemplary embodiments in FIGS. 1a to 3a are fastened in the respective base body 10.1, 10.2, 10.3 by being cast in place. In this case, the sockets 18.1, 18.2, 18.3 that are machined into the base body 10.1, 10.2, 10.3 and/or the dimensions of the respective connecting section 20.1, 20.2, 20.3 are sized so that between the base body 10.1, 10.2, 10.3 and the heat dissipating element 16.1, 16.2, 16.3, an interstice is formed after the insertion. This interstice between each connecting section 20.1, 20.2, 20.3 and the respective socket 18.1, 18.2, 18.3 can be filled in or filled up with a very thermally conductive casting compound that solidifies and preferably hardens. After the casting compound solidifies or hardens, the respective heat dissipating element is firmly connected to the base body 10.1, 10.2, 10.3.

Another alternative for fastening the heat dissipating elements 16.1, 16.2, 16.3 in the respective sockets 18.1, 18.2, 18.3 provided in the base bodies 10.1, 10.2, 10.3 can be achieved by means of gluing or sticking them in place with a suitable adhesive.

Another option for producing a connection between the heat dissipating elements 16.1, 16.2, 16.3 in the sockets 18.1, 18.2, 18.3 machined into the respective base body 10.1, 10.2, 10.3 is soldering. To that end, after being inserted into the corresponding socket 18.1, 18.2, 18.3 in the base body 10.1, 10.2, 10.3, the respective heat dissipating element 16.1, 16.2, 16.3 is soldered to the base body 10.1, 10.2, 10.3 in an intrinsically known way with a suitable solder.

In a modification, in order to achieve a better wetting of the heat dissipating element 16.1, 16.2, 16.3 composed of ceramic with solder, this element is previously metallized in the region of the connecting section 20.1, 20.2, 20.3.

FIG. 4a shows a fourth exemplary embodiment of a heat sink 4. Basically, that which has been stated about the exemplary embodiments in FIGS. 1a to 3b also applies correspondingly to the fourth exemplary embodiment.

The base body 10.4 of the fourth exemplary embodiment is rotationally symmetrical in comparison to the base bodies 10.1, 10.2, 10.3. The base body 10.4 can be produced as a turned element or produced by means of a CNC machine.

The base body 10.4 has an inner surface 12.4 of a recess 22 extending axially in the base body 10.4. The inner surface 12.4 is once again used for coupling to a heat source from which heat is to be dissipated by means of the heat sink.

The outer surface 14.4 of the base body 10.4 is part of the heat dissipating surface into which the sockets 18.4 for the heat dissipating elements 16.4 are machined. The sockets 18.4 are machined into the base body 10.4, for example by means of milling, in the form of axially extending slots.

Plate-shaped ceramic elements functioning as the heat dissipating elements 16.4 are inserted into the axially extending slots in order to enlarge the effective heat dissipating surface area. The heat dissipating elements 16.4 are spaced apart from one another uniformly and in a star-pattern around the circumference of the base body 10.4. A uniform enlargement of the effective heat dissipating surface area is thus achieved across the entire circumference region of the base body 10.4.

The heat sink 4 shown in FIGS. 4a and 4b is particularly well-suited for use, for example, as a heat sink for an anode of an X-ray tube used as an X-ray radiation generator of the kind that is known, for example, from DE 10 2008 006 620 A1. FIG. 5a shows a cross-section through an example of an X-ray tube 30, which has an anode 36 as a component that conducts a high voltage and heats up during operation. In order to cool the anode 36 during the operation of the X-ray tube 30, the heat sink 4 that is shown in FIGS. 4a and 4b, is fastened in a thermally conductive way to the part of the anode 36 leading out of the X-ray tube 30. In order to dissipate the heat from the heat sink, the X-ray tube is positioned in a tank (not shown) that is filled with oil acting as the insulating medium. The high heat capacity of oil makes it possible to transport heat away from the heat sink by means of the oil through the use of a heat exchanger. Basically, air could also be used as an insulating medium. Air does not have as good cooling properties, though.

The design of the X-ray tube 30 is essentially known; details thereof are also not relevant to the comprehension of the heat sink 4. The X-ray tube 30 essentially has an evacuated cylindrical housing 32, which is likewise composed of a ceramic. Firstly, the housing 32 contains a heated cathode 34, which can be contacted from the outside by means of corresponding lines 37 via corresponding through openings in the housing 32. Situated opposite from the cathode 34 is the anode 36, which during the operation of the X-ray tube 30, is acted on with a corresponding high voltage in order to accelerate the electrons emitted by the cathode 34. On the anode 36, there is a target 38, for example composed of tungsten, which is customarily provided in order to produce X-ray radiation. X-rays, which are generated by the electrons that penetrate into the target 38 and are decelerated by it, exit the X-ray tube 30 by means of a radiation window 40 in the housing 32. A titanium foil 42 can be positioned in the optical path for beam hardening of the X-ray radiation.

The connecting end of the cathode 34 leads out from the end 43 of the housing 32. At this location, the heat sink 4 is connected to the anode 36 in a way that provides good thermal conduction in order to dissipate the heat that is generated during operation.

FIG. 5b provides a supplementary perspective view of the X-ray tube 30 from FIG. 5a for the sake of better illustration.

1. An X-ray tube (30) with an anode (36) that conducts a high voltage, preferably greater than 120 kV, particularly preferably greater than 300 kV, and heats up during operation, wherein the anode is connected in a thermally conductive way to a heat sink (4), which has a base body (10.4) composed of a metal with a heat absorbing surface (12.4) for coupling to the anode (36) as a heat source (36) and a heat dissipating surface (14.4) that is enlarged by means of heat dissipating elements (16.4) that are connected to the base body (10.4), wherein the heat dissipating elements (16.4) are composed of an electrically insulating material having a thermal conductivity on the same order of magnitude as that of the metal of the base body (10.4), and wherein the heat dissipating elements (16.4) have a height (H) starting from the base body (10.4) of the heat sink (4) so that taking into account the high voltage and an insulating medium surrounding the heat dissipating elements (16.4), there is a sufficient insulation breakdown resistance relative to the surroundings of the X-ray tube (30).

2. The X-ray tube (30) according to claim 1, wherein the base body (10.4) is composed of a metal, in particular aluminum, copper, silver, or a metal alloy, which preferably has a thermal conductivity coefficient that is greater than 100 W/(m K) and particularly preferably, lies in the range of 100 to 450 W/(m K).

3. The X-ray tube (30) according to claim 1 or 2, wherein the heat dissipating elements (16.4) are composed of a ceramic, in particular of silicon carbide or aluminum nitride, which preferably has a thermal conductivity coefficient that is greater than 100 W/(m K) and particularly preferably, lies in the range of 100 to 350 W/(m K).

4. The X-ray tube (30) according to one of the preceding claims, wherein the heat dissipating elements (16.4) are plate-shaped or pin-shaped or tubular.

5. The X-ray tube (30) according to one of the preceding claims, wherein for each heat dissipating element (16.4), the base body (10.4) has a corresponding socket (18.4), which is dimensioned to accommodate (18.4) a connecting section (20.4) of each of the heat dissipating elements (16.4).

6. The X-ray tube (30) according to claim 5, wherein the heat dissipating elements (16.4) are connected to the base body (10.4) in that the respective connecting section (20.4) is fastened in the associated socket (18.4) by means of a press fit or clamping.

7. The X-ray tube (30) according to claim 5, wherein the heat dissipating elements (16.2; 16.3) are pin-shaped or tubular at least in the region of the connecting section (20.2; 20.3) and have a first thread in the connecting section (20.2; 20.3), the sockets in the base body (10.2; 10.3) are holes with corresponding second threads, and the heat dissipating elements (16.2; 16.3) are connected to the base body (10.2; 10.3) in that the connecting sections (20.2; 20.3) are each fastened in the respective socket (18.2; 18.3) by means of a screw connection.

8. The X-ray tube (30) according to claim 5, wherein the heat dissipating elements (16.4) are attached to the base body (10.4) by being cast in place and an interstice between the respective connecting section (20.4) and the socket (18.4) is filled with a casting compound.

9. The X-ray tube (30) according to one of the preceding claims, wherein the heat dissipating elements (16.4) are attached to the base body (10.4) by being glued with an organic or inorganic adhesive.

10. The X-ray tube (30) according to claim 5, wherein the heat dissipating elements (16.4) are attached to the base body (10.4) by means of soldering and preferably, at least the connecting section (20.4) of the heat dissipating element (16.4) is metallized.

11. The X-ray tube (30) according to one of the preceding claims, wherein the base body (10.4) is a turned element with an inner surface (12.4) of an axially extending recess (22) that is adapted for coupling to the anode (36) as the heat source, an outer surface (14.4) as part of the heat dissipating surface has the sockets (18.4) for the heat dissipating elements (16.4), and a heat dissipating element (16.4) is inserted into each of the sockets (18.4).

12. The X-ray tube (30) according to claim 11, wherein the sockets (18.4) are axially extending slots or grooves into which are inserted plate-shaped ceramic elements serving as the heat dissipating elements (16.4).
